(19) United States
(12) Patent Application Publication
(10) Pub. No.: US 2004/0137191 A1
(43) Pub. Date: Jul. 15, 2004

(54) Recyclable extrusion-coated carpet having improved fiber lock

(76) Inventor: James R. Beren, West Chester, PA (US)

Correspondence Address: BASELL USA INC., INTELLECTUAL PROPERTY, 912 APPLETON ROAD, ELKTON, MD, 21921, US

(21) Appl. No.: 10/342,970

(22) Filed: Jan. 15, 2003

(51) Int. Cl. B32B 33/00; D05C 17/00

(52) U.S. Cl. 428/95; 428/97; 156/72

(57) ABSTRACT

A carpet having improved tuft and fiber lock, which includes: (i) a primary carpet fabric, (ii) a secondary carpet backing or backcoat material of an olefin polymer material, and (iii) an acrylate adhesive applied to the primary carpet fabric.

### FIELD OF THE INVENTION

This invention relates to tufted carpets having an improved fiber lock and to a method of manufacturing them.

### BACKGROUND OF THE INVENTION

Tufted textile articles, such as tufted carpets, are made by inserting a plurality of vertical, reciprocating needles threaded with yarn into a moving primary backing fabric to form tufts of yarn which protrude through the primary backing fabric. Loopers or hooks, which work in a timed relationship with the stroke of the needles, are located below the primary backing fabric so that the loopers are positioned just above the needle eyes when the needles are at the lowest point in their downward stroke. When the needles reach the lowest point in their downward stroke, the yarn is picked up from the needles by the loopers and held momentarily. Loops or tufts of yarn embedded in the primary backing fabric are thus formed as the needles are drawn back through the primary backing fabric. This process is repeated when the previously formed loops are moved away from the loopers as the primary backing fabric is advanced.

The loops can be cut during the tufting process to form a cut pile as opposed to a loop pile construction. If a cut pile is desired, a looper and knife combination is used in the tufting process. The tufts of yarn inserted into, embedded in, and protruding through the primary backing fabric of a carpet are identified collectively as the carpet face or facing.

Additional information on the manufacture of tufted articles may be found in Rose, Stanley H., “Tufted Materials,” Man-Made Textile Encyclopedia, Chap. IX, Textile Book Publishers, Inc. (1959).

When the tufted textile article is a carpet, the primary backing fabric is typically a woven or nonwoven fabric made of one or more of natural and synthetic fibers, such as jute, wool, rayon, polyamides (such as, nylons), polyesters, propylene polymers and ethylene polymers, or of films of synthetic materials, such as propylene polymer and ethylene polymers as further described below.

The tufts of yarn inserted during the tufting process are usually held in place by the untwisting action of the yarn in combination with the shrinkage of the backing fabric. However, when the article is a tufted carpet, the back of the primary backing fabric may be coated with a backcoat material, such as a latex or an emulsion of natural or synthetic rubbers or synthetic resins, or a hot melt adhesive, to assist in locking or anchoring the tufts comprising the carpet face to the primary backing material, to improve the dimensional stability of the tufted carpet, to make the carpet more durable and to provide skid and slip resistance.

Often, a tufted carpet is further stabilized by laminating a secondary carpet backing in the form of a woven or nonwoven fabric made from fibers of jute, propylene polymer and ethylene polymers (suitable propylene and ethylene polymers are as described herein below) to the exposed or backcoated side of the primary backing fabric.

Carpets bonded with a synthetic rubber or synthetic resin latex backcoat generally do not employ precoat compositions, such as precoat resin dispersions, in their manufacture. When precoat compositions are used, they are applied to the backside of the primary backing fabric in an amount sufficient to penetrate the individual tufts of yarn, thereby increasing the resistance of the tufts to pull-out, and enhancing the bonding of the primary backing fabric to the secondary carpet backing. The amount of precoat necessary to penetrate the individual tufts will vary depending on the carpet yarn density and the efficacy of the precoat.

A “fiber tuft” is a cluster of soft yarns drawn through a fabric and projecting from the surface in the form of cut yarn or loops. “Fiber lock” is the binding of individual fibers within a carpet tuft, and is accomplished by penetration of the backcoat material into the tufts. “Tuft lock” is the amount of force required to pull an individual fiber tuft out of the carpet.

Various compositions have been proposed to bond the tufts comprising the carpet face or facing to the primary backing fabric. Thus, for example, U.S. Pat. No. 4,702,950 discloses a bitumen backed carpet tile which employs a first precoat layer consisting essentially of a hot-melt petroleum resin or bitumen to aid in retaining the back fibers to a primary backing fabric.

Acrylate emulsions have also been proposed for use in carpet precoat compositions. U.S. Pat. Nos. 4,640,953 and 4,604,311 disclose an aqueous precoat resin dispersion which has a solids content of about 63 to 69% comprising (1) at least one resin having a Ring and Ball softening point of from 60 to 100° C. in an aqueous dispersion having a solids content of about 53 to 58%; (2) at least one water-soluble polymer; (3) at least one cationic resin; and (4) water. Suitable resins include hydrocarbon resins prepared by polymerizing the component mixture of a C₅-C₉ stream. Polyterpene resins derived from α-pinene, β-pinene and monocyclic terpenes such as dipentene and rosin esters can be used. The water-soluble polymer has a molecular weight of from 100 to about 10,000 and can include polyacrylates such as polysodium acrylate and cellulose derivatives such as carboxymethyl cellulose. The cationic resin is preferably polyamide epichlorohydrin resin.

U.S. Pat. No. 5,196,468 discloses a solvent-free adhesive composition based on an aqueous acrylate latex containing 30 to 150% by weight based on the solids content of the acrylate latex of a mixture of 50-95% by weight of at least one tackifying resin and 5 to 50% by weight of a polyether of specified formula.

U.S. Pat. No. 4,731,402 discloses a floor covering adhesive based on aqueous polymer dispersions which comprise (a) a copolymer dispersion of 20-60% by weight of vinylidene chloride, 34-80% by weight of a mixture of acrylic acid esters, C₁-C₁₈ alkanols and vinyl esters, and 0.5 to 6% by weight an α,β-monoolefinically unsaturated C₃-C₅ mono- and/or dicarboxylic acids and/or amides thereof and/or vinyl sulfonate, (b) tackifying resins and (c) plasticizers and/or liquid resins and optionally (d) fillers.

U.S. Pat. No. 4,172,166 discloses a carpet comprising a tufted, non-woven polyester fabric backing reinforced by a binding fiber content and provided with at least one backcoating layer of at least partly thermoplastic material, and having tufting through the base, the improvement which comprises constructing the non-woven fabric so that at a temperature of 127° C. it has about 40 to 50% and at a temperature of 157° C. about 25 to 35% of its tensile strength at 22° C. The carpet preferably includes an acrylic resin backcoating layer on the non-woven fabric and a further layer of sintered polyethylene powder on top of the acrylic resin layer.

An object of the present invention is to provide a woven carpet having a secondary olefin polymer carpet backing which exhibits acceptable fiber lock and tuft lock.

Another object of the present invention is to provide a carpet having improved recyclability and dimensional stability.

Another object of the present invention is to provide a method for manufacturing a carpet having improved fiber lock, tuft lock, recyclability and dimensional stability.

A feature of the present invention is the use of an acrylate adhesive to bind fiber tufts to the primary backing fabric and to improve fiber lock by binding individual fibers within the tufts.

Another feature of the present invention is the use of an olefin polymer material as a backcoat material.

Another feature of the present invention is the use of an olefin polymer material as a combination backcoat material and secondary carpet backing.

### SUMMARY OF THE INVENTION

In one aspect, the present invention relates to a carpet having improved fiber and tuft lock, which comprises:

(i) a primary carpet fabric having tufts of yarn which protrude through a front side of a primary carpet backing material to form a carpet face;

(ii) an acrylate copolymer adhesive coated on a backside of the primary carpet fabric which binds the tufts of yarn to the primary carpet fabric and binds the fibers within the tufts;

(iii) an olefin polymer backcoat material adhered to the adhesive coated backside of the primary carpet fabric; and

(iv) optionally, a secondary backing consisting essentially of woven or nonwoven fabrics.

In a second aspect, the present invention relates to a method of manufacturing a carpet, comprising:

(i) precoating a back side of a primary carpet fabric with an aqueous emulsion of an acrylate copolymer;

(ii) (a) extrusion coating an olefin polymer material upon the precoated side of the primary carpet fabric, thereby forming a secondary carpet backing; or

(b) extrusion laminating, using an olefin polymer material, the precoated side of the primary carpet fabric to a separate secondary carpet backing consisting of woven or nonwoven fabrics; or

(c) both (a) and (b) starting with (a) followed by (b).

### DETAILED DESCRIPTION OF THE PREFERRED EMBODIMENTS

The primary carpet backing of the primary carpet fabric may be manufactured from propylene polymer yarns, tapes, films and split films. The accepted industry standard for woven backing is a 24×11 construction using warp yarn in the 450-500 denier range and fill yarns of 1100-1200 denier; however, other combinations are possible. Generally the woven propylene polymer substrates are needle punched with a light-weight fiber web (usually nylon) so as to provide a dyeable surface to match the coloration of the face yam. This is typically known in the trade under such trademarks as “Angel Hair”, “FLW”, or “FUZZ-BAC” and referred to generically as capcoating. This capcoated product is available from backing producers in a variety of fiber weight and fabric combinations. The primary purpose of the capcoat is to prevent “grin-through” when low density face pile (less than 28 oz/yd²) is used.

The carpet face of the primary carpet fabric may be selected from the group consisting of Berber, cut pile, and loop pile, and may be formed from fibers of wool, nylon, polyester and propylene polymers.

Suitable propylene polymers for use as the primary carpet backing or in the manufacture of fibers useful in the production of the carpet face or both include:

(A) a crystalline homopolymer of propylene having an isotactic index greater than 80%, preferably about 90% to about 99.5%;

(B) a crystalline random copolymer of propylene and an olefin selected from the group consisting of ethylene and C₄-C₁₀ α-olefins, provided that when the olefin is ethylene, the maximum polymerized ethylene content is 10% by weight, preferably about 4%, and when the olefin is a C₄-C₁₀ α-olefin, the maximum polymerized content thereof is 20% by weight, preferably about 16%, the copolymer having an isotactic index greater than 60%, preferably at least 70%;

(C) a crystalline random terpolymer of propylene and two olefins selected from the group consisting of ethylene and C₄-C₈ α-olefins, provided that the maximum polymerized C₄-C₈ α-olefin content is 20% by weight, preferably about 16%, and when ethylene is one of the olefins, the maximum polymerized ethylene content is 5% by weight, preferably about 4%, the terpolymer having an isotactic index greater than 85%;

(D) an olefin polymer composition comprising:

(i) about 10 parts to about 60 parts by weight, preferably about 15 parts to about 55 parts, of a crystalline propylene homopolymer having an isotactic index at least 80%, preferably about 90 to about 99.5%, or a crystalline copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight, preferably about 90% to about 99%, and an isotactic index greater than 60%;

(ii) about 3 parts to about 25 parts by weight, preferably about 5 parts to about 20 parts, of a copolymer of ethylene and propylene or a C₄-C₈ α-olefin that is insoluble in xylene at ambient temperature; and

(iii) about 10 parts to about 80 parts by weight, preferably about 15 parts to about 65 parts, of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than 70% by weight, preferably about 10% to about 60%, most preferably about 12% to about 55%, of ethylene and being soluble in xylene at ambient temperature and having an intrinsic viscosity of about 1.5 to about 4.0 dl/g; the total of (ii) and (iii), based on the total olefin polymer composition being from about 50% to about 90%, and the weight ratio of (ii)/(iii) being less than 0.4, preferably 0.1 to 0.3, wherein the composition is prepared by polymerization in at least two stages;

(E) a thermoplastic olefin comprising:

(i) about 10% to about 60%, preferably about 20% to about 50%, of a propylene homopolymer having an isotactic index at least 80%, preferably 90-99.5% or a crystalline copolymer selected from the group consisting of (a) ethylene and propylene, (b) ethylene, propylene and a C₄-C₈ α-olefin, and (c) ethylene and a C₄-C₈ α-olefin, the copolymer having a propylene content greater than 85% and an isotactic index of greater than 60%;

(ii) about 20% to about 60%, preferably about 30% to about 50%, of an amorphous copolymer selected from the group consisting of (a) ethylene and propylene, (b) ethylene, propylene, and a C₄-C₈ α-olefin, and (c) ethylene and a α-olefin, the copolymer optionally containing about 0.5% to about 10% of a diene, and containing less than 70% ethylene and being soluble in xylene at ambient temperature; and

(iii) about 3% to about 40%, preferably about 10% to about 20%, of a copolymer of ethylene and propylene or an α-olefin that is insoluble in xylene at ambient temperature; and

(F) mixtures thereof.

The acrylate adhesive used in the present invention may be an aqueous emulsion of ethylene/methyl acrylate copolymer, ethylene/n-butyl acrylate copolymer, or a styrene/acrylate copolymer. The aqueous acrylate emulsion may optionally contain pH buffers, and biocides in conventional amounts as long as these optional components do not affect the adhesive properties of the acrylate. Typically the emulsion contains from 10 to 70% by weight solids, preferably from 10 to 60%, most preferably from 13 to 55% by weight solids.

The aqueous emulsion may be applied to the back surface of the primary carpet fabric by conventional techniques such as direct coating, roller coating, or spraying. The aqueous acrylate copolymer emulsion coating is then dried, optionally with the aid of heat, to form a precoated primary backing fabric. For an emulsion of ethylene/methyl acrylate or ethylene/n-butyl acrylate copolymer, a dried coating weight of at least 0.5 oz. of the acrylate adhesive per square yard of carpet backing is most preferred. Dry coating weights from 0.5 to 12 oz. can be used. Dry coating weights from 0.5 to 8 are preferred with weights from 0.5 to 3 being especially preferred. For a styrene/acrylate copolymer emulsion, a dried coating weight of at least 0.5 oz. per square yard is preferred, with a dried coating weight of 0.5 to 1.0 oz. per square yard being especially preferred.

The olefin polymer backcoat material can be a propylene polymer, an ethylene-vinyl acetate copolymer, an ethylene polymer or an ionomer of ethylene-methacrylic acid with the acid neutralized with zinc or sodium, such as the Surlyn products available from E. I. du Pont de Nemours and Company.

Suitable propylene polymers for use as the olefin polymer backcoat material include those listed herein above for the primary carpet backing or for the manufacture of fibers useful in the production of the carpet face.

Typical ethylene polymers useful as the olefin polymer backcoat material include (a) homopolymers of ethylene, (b) random copolymers of ethylene and an alpha-olefin selected from the group consisting of C₃₋₁₀ alpha-olefins having a maximum polymerized alpha-olefin content of about 20 wt %, preferably a maximum of about 16 wt %, by weight, (c) random terpolymers of ethylene and said alpha-olefins, provided that the maximum polymerized alpha-olefin content is about 20 wt %, preferably the maximum is about 16 wt %, by weight, and (d) mixtures thereof. The C₃₋₁₀ alpha-olefins include the linear and branched alpha-olefins such as, for example, propylene, 1-butene, isobutylene, 1-pentene, 3-methyl-1-butene, 1-hexene, 3,4-dimethyl-1-butene, 1-heptene, 3-methyl-1-hexene, 1-octene and the like.

When the ethylene polymer is an ethylene homopolymer, it typically has a density of 0.89 g/cm³ or greater, and when the ethylene polymer is an ethylene copolymer with a C₃₋₁₀ alpha-olefin, it typically has a density of 0.91 g/cm³ or greater but less than 0.94 g/cm³. Suitable ethylene copolymers include ethylene/butene-1, ethylene/hexene-1, ethylene/octene-1 and ethylene/4-methyl-1-pentene. The ethylene copolymer can be a high density ethylene copolymer or a short chain branched linear low density ethylene copolymer (LLDPE), and the ethylene homopolymer can be a high density polyethylene (HDPE) or a low density polyethylene (LDPE). Typically the LLDPE and LDPE have densities of 0.910 g/cm³ or greater to less than 0.940 g/cm³ and the HDPE and high density ethylene copolymer have densities of greater than 0.940 g/cm³, usually 0.95 g/cm³ or greater. In general, ethylene polymer materials having a density from 0.89 to 0.97 g/cm³ are suitable for use in the practice of this invention. Preferably the ethylene polymers are LLDPE and HDPE having a density from 0.89 to 0.97 g/cm³.

When the olefin polymer backcoat material is formed from propylene polymer, it is preferably a recyclable propylene polymer having from very low to medium softness, such as described in (D) above. Such propylene polymers offer the advantage of being flexible without containing plasticizers, and are commercially available from Basell USA Inc. A preferred example is Adflex KS357P propylene polymer, which is a low modulus resin having a melt flow rate (MFR) of 0.25 g/10 min., measured according to ASTM-D 1238 (230° C.; 2.16 Kg); and an elongation at break of 800%, an elongation at yield of 55%, a tensile strength at break of 2600 psi, and a tensile strength at yield of 950 psi, with each of these last three properties being measured according to ASTM-D 638.

The precoated primary carpet backing of the primary carpet fabric is backcoated with the olefin polymer material using conventional techniques, with extrusion coating being preferred. The extrusion temperature will typically be at least 400° F., but could be as low as 350° F. when an ethylene-vinyl acetate copolymer is used as the olefin polymer material.

A separate secondary backing and the precoated primary backing layer may be laminated together by the application of heat and pressure. A preferred embodiment is to use the olefin polymer backcoating material to extrusion laminate the separate secondary backing to the precoated primary backing layer as the olefin polymer backcoating material is extruded. Another embodiment would include extrusion coating the olefin polymer backcoating material onto the precoated primary backing fabric and then running this backcoated, precoated primary carpet backing and the separate secondary backing material through a pair of (optionally heated) nip rollers.

The carpet of the present invention may be used in a wide variety of conventional fiber applications, including floor coverings and automotive interior applications. The carpeting can be installed using conventional techniques well known to those of ordinary skill in the art.

Unless otherwise specified, all references to parts, percentages and ratios in this specification refer to percentages by weight.

### EXAMPLES

The following examples illustrate aspects of this invention. They are not intended to limit the invention. Modifications of the specific precoat compositions, hot melt adhesive materials, tufted carpets and procedures of these examples can be made without departing from the spirit and scope of this invention.

Fiber Lock Evaluation of Berber Carpets:

Fiber lock was measured by repeatedly passing a weighted Velcro-covered roller over the carpet face and subjectively rating the degree of pilling and fuzzing on a scale of 1 (worst) to 5 (best). More particularly, a Velcro roller having a Velcro Hook Size of #88 was first brushed with a stiff nylon bristle brush to remove any lint or fiber from previous testing. The cleaned Velcro roller was then placed on the top surface of a 9×9 inch carpet square. The roller was then rolled forward and backward in the tuft direction for a total of twenty passes using just the weight of the roller. The amount of carpet fiber adhering to the roller was then examined visually by an informal panel. A numeric rating was assigned to each carpet specimen using the following fiber lock or pill & fuzz (the carpet industry typically refers to this rating as “pill & fuzz”) reference standards:

TABLE 1
Fiber Lock or Pill & Fuzz Reference Grades

| | |
|---|---|
| 5 | No visible fuzzing (Best) |
| 4 | Slight fuzzing |
| 3 | Moderate fuzzing |
| 2 | Considerable fuzzing |
| 1 | Severe fuzzing (Worst) |

Comparative Fiber Lock Evaluation of Cut-Pile Automotive Interior Carpets:

The fiber lock of cut-pile automotive carpets which are not affected by the Velcro roller was compared by pressing duct tape (Grade PC-609 from Shurtape, Hickory, N.C.) against the carpet faces and visual evaluation of the quantity of fiber which was removed when the tape was pulled off by the panel. The comparative results are set forth below in Example 5.

Tuft Lock Determination:

Tuft lock was measured by determining the amount of force required to pull individual tufts out of a carpet face from the primary carpet fabric which had been coated on its backside with some combination of adhesive precoat(s) and/or backcoat(s). An Instron Series IX automated materials testing system was used, with a crosshead speed of 12.00 in/min and a sample rate of 6.6670 pts/second, at a relative humidity of 65% and a temperature of 70° F. Tuft lock was reported in pound-foot units.

### Example 1

The backsides of several primary carpet fabric having propylene homopolymer Berber faces are precoated with an acrylic emulsion using a Meyer rod, and then drying (some with a heat gun, others by air drying) prior to being extrusion backcoating with Adflex KS357P propylene polymer at a coating thickness of 11.9 mils, a melt temperature of 450° F., a nip roll gap of approximately 3/16 inch and a chill roll temperature of 70° F.

All of the emulsion precoated samples have a fiber lock rating of 4.5 by the panel, which compares favorably with the 4.0 fiber lock value of an identical Berber carpet having a latex backcoating rather than an Adflex propylene polymer backcoating. Samples having extrusion coats with Adflex propylene polymer backcoating, but without the emulsion precoat, have fiber lock ratings of 1 by the panel.

Tuft lock test results are shown in Table 2. The lack of difference between the air-dried samples and those dried with a heat-gun indicates that long absorption time is not required for the emulsion coating to be effective.

TABLE 2
Tuft Lock Results

| Sample | Precoat Emulsion | Drying Method | Tuft Lock |
|---|---|---|---|
| 1 | Acrylate copolymer¹ | Air | 40.400 |
| 2 | Olefin/Acrylate graft copolymer² | Air | 25.100 |
| 3 | Olefin/Acrylate graft copolymer | Heat-gun | 26.170 |
| 4 | Acrylate copolymer | Heat-gun | 36.630 |

¹BASF 7A emulsion with 55 wt. % solids (supplied by Reedy International, Keyport, NJ).
²BASF 5 emulsion with 38% solids (supplied by Reedy International, Keyport, NJ).

### Comparative Example 1

A variety of primary carpet fabric having yam faces made from various polymer fibers, comprising a Berber propylene homopolymer (PP), a propylene homopolymer or a random propylene/ethylene copolymer with less than 4 wt. % polymerized ethylene (individually “PP”) cut pile, a propylene homopolymer or a random propylene/ethylene copolymer with less than 4 wt. % polymerized ethylene (individually “PP”) loop, or a nylon cut pile (CP) are extrusion backcoated with Adflex KS357P propylene polymer or a blend of 75% Adflex KS357P propylene polymer and 25% repelletized carpet edge trim, without any adhesion coating. Coating thicknesses of 11 (samples A, B, C, D, I, J, K and L) and 7 (samples E, F, G, H, M, N, O and P) mils are applied using a melt temperature of 450° F. and a nip roll gap of approximately 3/16 inch. Test results for the 11 mil thick coating samples are shown in Table 3. There is no fiber lock determination for the 7 mil thick coating samples because the results for the 11 mil thick coating samples are so poor.

TABLE 3

| | | % Adflex polymer/ | Tuft | Fiber |
|---|---|---|---|---|
| Sample | Description | % Edge Trim | Lock | Lock |
| A | Graphics Loop | 100/0 | 4.863 | 1/1 |
| B | Graphics Loop | 75/25 | 5.200 | 1/1 |
| C | Level Loop | 100/0 | 7.639 | 1/1 |
| D | Level Loop | 75/25 | 11.024 | 1/1 |
| E | CP Nylon Shifted | 100/0 | 1.617 | |
| F | CP Nylon Shifted | 75/25 | 0.990 | |
| G | CP Nylon Straight | 100/0 | 0.506 | |
| H | CP Nylon Straight | 75/25 | 0.593 | |
| I | PP Berber Shifted | 100/0 | 16.318 | 1/1 |
| J | PP Berber Shifted | 75/25 | 19.518 | 1/1 |
| K | PP Berber Straight | 100/0 | 11.943 | 1/1 |
| L | PP Berber Straight | 75/25 | 13.673 | 1/1 |
| M | PP Cut Pile Shifted | 100/0 | 4.131 | |
| N | PP Cut Pile Shifted | 75/25 | 6.840 | |
| O | PP Cut Pile Straight | 100/0 | 3.200 | |
| P | PP Cut Pile Straight | 75/25 | 4.741 | |

### Example 2

A primary carpet fabric stitched with a Berber propylene homopolymer fiber face was coated with BASF 7A acrylate emulsion having 55 wt. % solids (supplied by Reedy International, Keyport, N.J.) using a hand coating apparatus typically used to test printing inks. The coating was dried with a heat gun, and the coating weight measured by comparing the weights of uncoated coated areas. The hand coater provides good control of coating weight, with one application providing approximately 5 oz. per square yard of the acrylate copolymer emulsion.

The samples of primary carpet fabrics stitched with Berber propylene homopolymer fiber faces are coated with 1, 2, 3, 4 or 5 passes of the hand coating apparatus. The acrylate coatings and dried, and the coated samples are then extrusion coated with 11 mil thick coatings of Adflex KS357P propylene polymer using the same procedures of Example 1. Fiber lock test data by the panel using the numerical ratings of Table 1 are shown below in Table 4.

TABLE 4

| | Coating | Dry Coating | Fiber |
|---|---|---|---|
| Sample | Passes | Weight (oz/yd²) | Lock |
| 1 | 0 | 0 | 1 |
| 2 | 1 | 5 | 2 |
| 3 | 2 | 10 | 4 |
| 4 | 3 | 15 | 4 |
| 5 | 4 | 20 | 4 |
| 6 | 5 | 25 | 4 |

The optimum coating weight appears to be 10 oz. per square yard based on the test data in Table 4. Optimization of the coating process with respect to parameters such as emulsion viscosity, application pressure, drying conditions, application angle and subsequent extrusion coating conditions may permit the use of a lower coating weight.

### Example 3

A primary carpet fabric having Berber propylene homopolymer fiber face is coated with about 0.67 oz. per square yard (dry weight) of a Vancryl 960 emulsion (commercially available from Air Products and Chemicals, Inc.) comprising a 45 wt. % solids aqueous emulsion of a styrene/acrylate copolymer emulsion having a Tg of 39° C., a viscosity of 1,000 centipoise and a number average molecular weight of greater than 200,000. The emulsion is allowed to air dry to form an adhesive coating and then an 11 mils thick coating of Adflex KS357P propylene polymer is extruded over the adhesive coating using a Killion sheet extruder. The fiber lock rating by the panel for the resulting carpet is 4.5.

### Example 4

A primary carpet fabric having Berber propylene homopolymer face is coated with BASF 7A acrylate emulsion having 55 wt. % solids (supplied by Reedy International, Keyport, N.J.) using a Campbell Hausfeld, Model #DH6500 paint sprayer (commercially available from The Campbell Group, Harrison, Ohio). (The paint sprayer allows more control when using dilute emulsions.) The emulsion from Example 1 is evaluated both after being diluted with water to 50% of its original solids content and after being diluted to 25% of its original solids content. The results are shown below.

| | Diluted | | | | Pill & |
|---|---|---|---|---|---|
| | Emulsion | Wet Wt. | Undiluted Wt. | Dry Wt. | Fuzz |
| Sample | (% solids) | (oz/sq yd) | (oz/sq yd) | (oz/sq yd) | Rating |
| A | 27.5% | 10 | 5 | 2.75 | 5 |
| B | 27.5% | 7 | 3.5 | 1.93 | 4.8 |
| C | 27.5% | 4 | 2 | 1.1 | 4.1 |
| D | 13.75% | 10 | 2.5 | 1.38 | 4.8 |
| E | 13.75% | 7 | 1.75 | 0.96 | 4.5 |
| F | 13.75% | 4 | 1 | 0.55 | 4 |

The results show that by applying a more dilute emulsion by spraying, one can obtain a satisfactory fiber lock using as little as 0.55 oz/sq. yd by dry weight of the emulsion. As stated before, current commercial carpets typically have a fiber lock or pill & fuzz rating of 4.

### Example 5

Automotive cut pile carpeting (made from PP fibers) is emulsion precoated by spraying BASF 7A acrylate emulsion (supplied by Reedy International, Keyport, N.J.) at 27.5 wt. % solids (a 50% dilution from that supplied) onto the backing, allowing the emulsion to air dry, and extrusion coating 11 mils of various olefin polymers over the precoat. The same olefin polymers are also extrusion coated in like manner onto the back of carpet samples which are not precoated. The olefin polymers are Adflex KS357P propylene polymer (described above), Surlyn 1652 ionomer resin, low density polyethylene (LDPE) (0.917 density, 7 melt index (MI), commercially available from Chevron Phillips Chemical Company LP, The Woodlands, Tex.) and Elvax ethylene-vinyl acetate copolymer (commercially available from E. I. du Pont de Nemours and Company). In all cases, a comparison of the sample having an emulsion precoat and an olefin polymer extrusion coating to the sample having the same olefin polymer extrusion coating without the emulsion precoat by the panel, demonstrates that the samples precoated with the emulsion retain more fibers and release fewer to the pulled tape than those without emulsion precoats. A sample is also tested having the emulsion precoat but without an extrusion coating of polyolefin. This sample exhibits extremely poor fiber retention, demonstrating that the combination of an emulsion precoat and an extruded polyolefin provides the good or improved fiber lock.

Other features, advantages and specific embodiments of this invention will become apparent to those exercising ordinary skill in the art after reading the foregoing disclosures. Such specific embodiments are within the scope of this invention. Moreover, while specific embodiments of the invention have been described in considerable detail, the invention is not limited thereto, and variations and modifications of those embodiments can be effected without departing from the spirit and scope of the invention.

I claim:

1. A tufted carpet having improved fiber lock comprising:
(i) a primary carpet fabric having tufts of yam with fibers within the tufts which tufts protrude through a front side of a primary carpet backing to form a carpet face;
(ii) an acrylate adhesive coated on a backside of the primary carpet fabric which binds the tufts of yam to the primary carpet fabric and binds the fibers within the tufts, and
(iii) an olefin polymer secondary backing material or backcoat material adhered to the adhesive coated backside of the primary carpet fabric.

2. The carpet of claim 1, wherein the carpet face yam is selected from the group consisting of Berber, cut pile and loop pile.

3. The carpet of claim 3, wherein the yam is made from fibers of wool, nylon, polyester, propylene polymers or mixtures thereof.

4. The carpet of claim 1, wherein the acrylate adhesive is selected from the group consisting of ethylene/methyl acrylate, ethylene/n-butyl acrylate and styrene/acrylate copolymers.

5. The carpet of claim 4, wherein the acrylate adhesive is a styrene/acrylate adhesive copolymer.

6. The carpet of claim 5, wherein the coating weight of the acrylate adhesive is at least 5 oz. per square yard of primary carpet fabric.

7. The carpet of claim 4 wherein the coating weight is between 8 and 12 oz. per square yard.

8. The carpet of claim 5, wherein the coating weight is between 8 and 12 oz. per square yard.

9. The carpet of claim 8, wherein a dry coating weight of the acrylate adhesive is between 0.5 and 1.0 oz. per square yard.

10. The carpet of claim 4, wherein the acrylate adhesive is the dried residue left by application of an aqueous emulsion of acrylate copolymer containing 10 to 70% solids by weight.

11. The carpet of claim 4, wherein the acrylate adhesive is the dried residue left by application of an aqueous emulsion of acrylate copolymer containing 10 to 60% solids by weight.

12. The carpet of claim 5, wherein the acrylate adhesive is the dried residue left by application of an aqueous emulsion of acrylate copolymer containing 13 to 55% solids by weight.

13. The carpet of claim 1, wherein the olefin polymer backcoat is selected from the group consisting of propylene polymers, ethylene-vinyl acetate copolymers, ethylene polymers and ionomers of ethylene-methacrylic acid with the acid neutralized with zinc or sodium.

14. The carpet of claim 13, where is the olefin polymer backcoat is a propylene polymer having comprises at least 70% by weight polypropylene having a MFR of 25 g/10 minutes measured according to ASTM-D 1238 (230° C.; 2.16 Kg), and an elongation at break of 800% and an elongation at yield of 55%, both measured according to ASTM-D 638.

15. A method of manufacturing a carpet having improved fiber lock, comprising the steps of:
(a) precoating one side of a primary carpet fabric with an aqueous emulsion of an acrylate copolymer selected from the group consisting of ethylene/methyl acrylate, ethylene/n-butyl acrylate, and styrene/acrylate copolymers;
(b) (i) extrusion coating an olefin polymer onto the precoated side of the primary carpet fabric, thereby forming a secondary carpet backing; or
(ii) extrusion laminating a separate secondary carpet backing to the precoated side of the primary carpet fabric using an olefin polymer.

16. The method of claim 15, wherein the acrylate copolymer is a styrene/acrylate copolymer.

17. The method of claim 15, wherein the aqueous emulsion of acrylate copolymer contains 13 to 55% solids by weight.

18. The method of claim 16, where the styrene/acrylate copolymer contain 13 to 55% solids by weight.

19. The method of claim 15, wherein the secondary carpet backing is laminated onto the precoated side of the primary carpet backing by means of nip rollers.
